(19) United States
(12) Patent Application Publication
(10) Pub. No.: US 2006/0171324 A1
(43) Pub. Date: Aug. 3, 2006

(54) Using signaling to provide interoperability of ADPCM encoded voice communications

(76) Inventors: Satish Kumar M. Mundra, Germantown, MD (US); Daniel C. Thomas, Germantown, MD (US); David A. Lide, Rockville, MD (US)

Correspondence Address: TEXAS INSTRUMENTS INCORPORATED, P O BOX 655474, M/S 3999, DALLAS, TX, 75265, US

(21) Appl. No.: 11/050,338

(22) Filed: Feb. 3, 2005

(51) Int. Cl. H04L 12/66; H04L 12/26

(52) U.S. Cl. 370/252; 370/352

(57) ABSTRACT

Providing interoperability on a voice communication network by detecting incompatible bit packing payload formats of ADPCM encoded voice data signals in an encoder/decoder. A mismatch of bit packing formats between little endian format and big endian format is determined through the use of a media gateway control protocol package called Real Time Protocol that allows a Call Agent to detect the presence of garbled audio and allows an intelligent gateway to detect the payload format being used by remote endpoints during call setup procedures and then switch the gateway's encoding for the payload to the payload format being used by the remote endpoint. The invention may be applied to an ITU G.726 encoder/decoder.

### CROSS-REFERENCE TO RELATED APPLICATIONS

None

### FIELD OF THE INVENTION

The present invention relates to using a call flow for detecting and resolving interoperability problems between a single voice codec using different payload formats. The invention can be applied to ITU G.726 interoperability issues.

### BACKGROUND OF THE INVENTION

In typical telecommunications systems, voice calls and data are transmitted by carriers from one network to another network. Networks for transmitting voice calls include packet-switched networks transmitting calls using voice over Internet Protocols (VoIP), circuit-switched networks like the public switched telephone network (PSTN), asynchronous transfer mode (ATM) networks, etc. Recently, voice over packet (VOP) networks are becoming more widely deployed. Many incumbent local exchange and long-distance service providers use VoIP technology in the backhaul of their networks without the end user being aware that VoIP is involved.

An example of networks and components for a VoIP call is illustrated in FIG. 1. The diagram shows a communication network that could be any managed network accessing the Internet such as an packet network with IP protocols, Asynchronous Transfer Mode (ATM), or Ethernet network. The communications network comprises a router 14 connected to various customer premise equipment and to media gateway 12. Media gateway 12 must be capable of detecting changing resource or network conditions. The ability to detect and monitor changing resource and network conditions can result in significant cost reductions and/or improved quality. Router 14 is connected to Internet Access Device (IAD) 16, wireless access point (AP) 22, and/or IP PBX (personal branch exchange) 23. A voice call may be placed between any of the customer equipment phones 18 connected to IAD 16, wireless IP phone 24 connected to AP 22, or IP PBX phone 30 and POTS (plain old telephone system) phone 32. Using special software, calls could also be placed through computer 20 connected to IAD 16 or portable computer 26 connected to AP 22.

Customer equipment is connected through access broadband network 28 to the Internet 34 by media gateway 12. On the far end is the PSTN 48 connected to POTS phone 52 through a Central Office 50. PSTN 48 is also connected to the Internet 34 through a trunk gateway, composed of signal gateway 46, media gateway controller/proxy (MGC) 32, and trunk media gateway (MG) 42. IP and packet data (e.g., real time protocol (RTP packet data)) associated with the call is routed between IAD 16 and trunk MG 42. The trunk gateway system provides real-time two-way communications interfaces between the IP network (e.g., the Internet) and the PSTN 48. As another example, a VoIP call could be initiated between WIPP 24 and WIPP 40 connected to AP 38. In this call, voice signals and associated packet data are sent between MG 12 and MG 48 through Internet 34, thereby bypassing the PSTN 48 altogether.

Factors that affect voice quality in a VoIP network are fairly well understood. The level of control over these factors will vary from network to network. This is highlighted by the differences between a well-managed small network enterprise verses an unmanaged network such as the Internet. Network operational issues affect network performance and will create conditions that affect voice quality. These issues include outages/failures of network switches, routers, and bridges; outages/failure of VoIP elements such as call servers and gateways; and traffic management during peak periods and virus/denial of service attacks.

Interoperability between VoIP systems is a critical ingredient of high-quality VoIP systems. There are many software and hardware devices in a VoIP system that must be implemented in order to reach the quality of carrier-class systems. The most important software features include echo cancellation, voice compression, packet play-out software, tone processing, fax and modem support, packetization, signaling support, and network management. New networking technologies and deployment models are also causing additional challenges that affect the ability of VoIP service providers to guarantee the highest levels of service quality (e.g., toll quality) in their deployments. Two such examples are where the VoIP service provider does not control the underlying packet transport network, and the use of packet networks with potentially high delay and loss, such as in 802.11 WLAN (Wireless Local Area Network) technology.

A problem affecting the interoperability of VoIP systems, and hence the quality of voice systems, is a problem with interoperability between two widely-used but incompatible packing formats for Real-time Protocol (RTP) loads when using ADPCM. Adaptive Differential Pulse-Code Modulation (ADPCM) is a widely-used coding technique for digital communications over a computer network that uses a method of predictive coding to achieve data reduction. An advantage of ADPCM is a bit rate reduction by the use of an adaptive scale factor and quantizing according to a fixed quantization curve. The result of the incompatible packing formats is garbled audio when a caller implements one of the formats and a receiver implements the opposing format.

One standard is the ITU-T standard G.726, titled “40, 32, 24, 16 kbit/s ADAPTIVE DIFFERENTIAL PULSE CODE MODULATION (ADPCM),” describes an algorithm for conversion of a single 64 kbit/s A-law or mu-law PCM channel encoded at 8,000 samples/s to and from a 40, 32, 24, or 16 kbit/s channel. The conversion is applied to the data stream using ADPCM transcoding methods. The G.726 data rates of 40, 32, 24, and 16 kbit/s have codewords of 5, 4, 3, and 2 bits, respectively, and are described as G726-40, G726-32, G726-24, and G726-16. Samples for G.726 encoding must be packed into octets using “little endian” ordering. Big endian or little endian packing methods indicate packing bytes in a certain order according to what bytes are most significant or least significant. Big endian systems sequence bits where the most significant bit in a sequence is stored at the lowest, or first, storage address, whereas in a little endian format the least significant bit in the sequence is stored first.

For G.726 the 4-bit code words must be packed into octets wherein the first code word is packed in the four LSBs of the first octet and with the LSB of the code word in the LSB of the octet. The second code word is placed in the four MSBs of the first octet, with the MSB of the second code word packed into the MSB of the octet. The packing of code words continues in this manner with the first code word of each pair of words placed in the least significant four bits of the octet, and so forth.

The “little endian” method for packing samples into octets in the G726-16, -24, -32, and -40 formats for RTP payloads is the same packing method that is specified in ITU-T Recommendation X.420 for packing ADPCM samples into octets. IETF adopted this format for G72640, -32, -24, -16 RTP payloads.

The opposing packing format is the ITU-T Recommendation I.366.2 Annex E for ATM AAL2 transport that specifies big-endian format for the same. This has resulted in interoperability problems in the VoIP industry as many vendors have adopted the AAL2 format for RTP payloads too.

The revised AVT-RTP-Profile (RFC 3551) has attempted to resolve this issue by discontinuing the use of payload type “2” for G726-32 and has recommended the use of dynamic RTP payload type. Also for the I.366.2 (Annex E) format a new MIME subtypes of AAL2-G726-16, -24, -32, -40 are specified and MIME registration of the same is expected to happen soon. This probably can solve the problem in some implementations going forward, however, interoperability with installed base of VoIP devices is not ensured.

G726-32 with dynamic payload is likely to indicate that the payload conforms to IETF specification, however, there is nothing that prevented use of dynamic payload for G726-32 in older implementations. Thus, in many older implementations the type of payload format cannot be determined remotely. Moreover G726-16, -24, and -40 have always used dynamic payloads, so relying on payload alone can result garbled audio.

A gateway compliant with RFC 3551 and implanting G.726 can probably support G726-XX as well as AAL2-G726-XX payload formats. However, when the gateway's SDP contains G726-XX alone, there is no way for gateway to determine the payload format conclusively. For some signaling protocols, it may be possible to indicate support for both payload formats. However, there is no method for an existing gateway to determine if the payload format of a remote gateway negotiates using only G726 as described above.

One solution for ADPCM interoperability is proposed in the IETF's RFC 3551 standard “RTP Profile for Audio and Video Conferences with Minimal Control,” by Schulzrinne, H. and Casner, S. (July, 2003). RFC 3551 has only solved the issue for interoperability among future systems, as far as currently existing systems in the field are concerned the gateways can not determine the payload format conclusively. Clearly, there is a need for gateway to determine the G.726 payload format conclusively to prevent garbled audio output when it encounters non-complaint systems.

### SUMMARY

To overcome the drawbacks of the prior art, the present invention solves the problem of G.726 ADPCM interoperability of different bit packing methods used in payload formats. by For signaling protocols such as MGCP/MEGACO one can define a package such that Call-Agent when ITU G.726 is used as a codec and can facilitate the bit packing format verification by briefly putting the remote connection in netwtest mode or continuity test mode so that a gateway supporting this package can easily determine the format used by remote.

The preferred method uses an MGCP Package such that a Call Agent can facilitate bit packing format verification of either G.726 bit endian or little endian payload formats. An advantage to the invention is that it provides seamless interoperability for VoIP systems using G.726 protocols with that have legacy systems using ML2-G726-XX payload formats, and vice-versa.

The present invention uses a call flow that Call Agents can employ to allow endpoints to detect G726 interoperability problem and allow intelligent implementations to resolve the problem. There are two incompatible G726 payload formats that are in use today. Recent implementations support both payload formats and are identified by different MIME subtypes, however interoperability with existing gateways in the field is not ensured. The call flow described in the preferred embodiment uses a basic MGCP package called G726, which will allow a Call Agent to detect the presence of garbled audio and allows an intelligent gateway to detect the payload format being used by remote endpoints during call setup procedure and switch it's encoding for the payload to the one being used by remote.

It may be desirable to indicate the capability to interoperate with any G726 implementation using the call flow proposed here. This can be accomplished by defining an empty package, for e.g. “G726”, with no signals or events. This document also defines a general purpose media descriptor (gpmd) parameter called “endian” which can be registered with IANA which will allow Call Agent/Gateways to identify the payload format in some cases.

### BRIEF DESCRIPTION OF THE DRAWINGS

For a better understanding of the nature of the present invention, its features and advantages, the subsequent detailed description is presented in connection with accompanying drawings in which:

FIG. 1 is a diagram of a packet network using voice over Internet Protocols (VoIP);

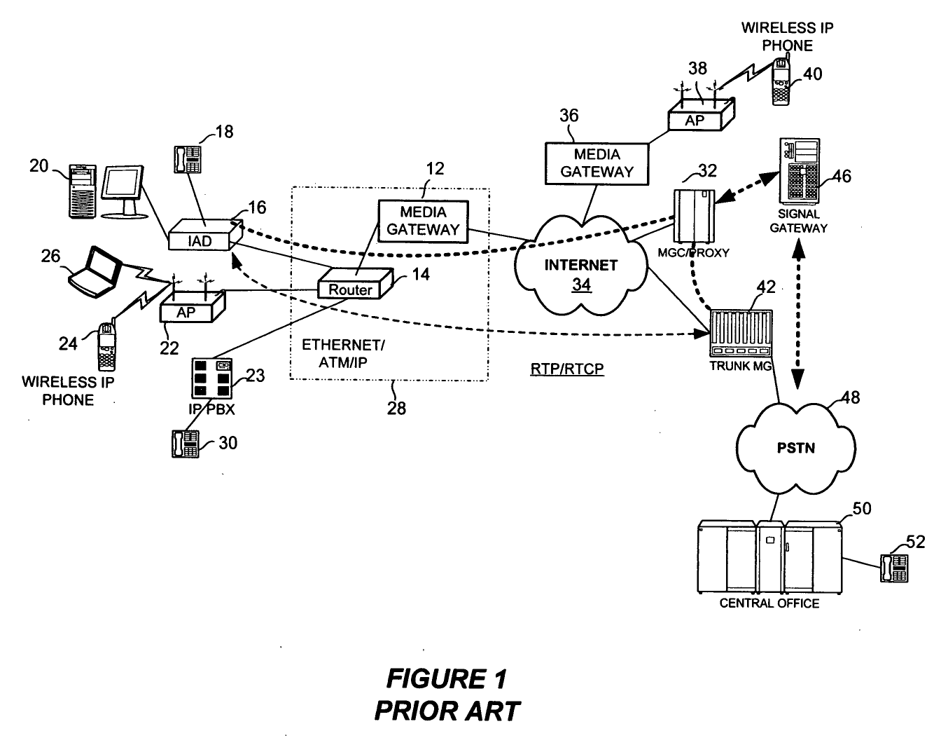

FIG. 2 is a network diagram illustrating gateway devices implementing the signaling protocol of the preferred embodiment;

FIG. 3 is a flowchart diagram using signaling to determine ADPCM interoperability between an originating intelligent gateway and a terminating legacy gateway;

FIG. 4 is a flowchart diagram using signaling to determine ADPCM interoperability between an originating legacy gateway and a terminating intelligent gateway.

### DETAILED DESCRIPTION OF THE INVENTION

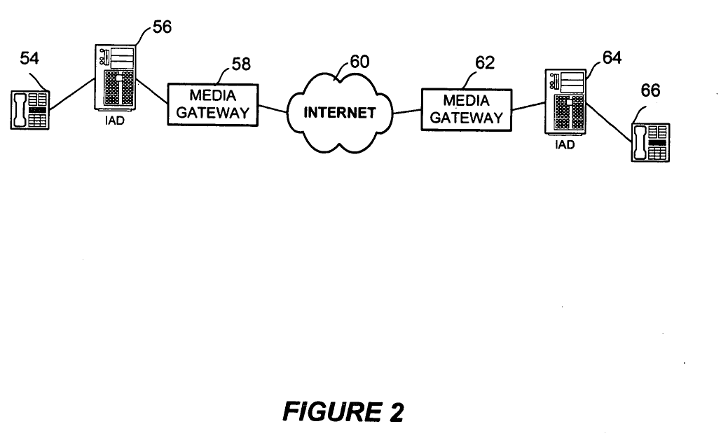

The present invention provides a system and method for interoperability between the RTP payload formats using ITU G.726 encoding method using little endian ordering for ADPCM and the RTP payload formats specified in ITU-T I.366.2 Annex E for ATM AAL2 transport that uses big endian ordering. A system for the preferred embodiment for is represented in the network diagram of FIG. 2. The diagram depicts a network used for placing a call using voice over Internet Protocol (VoIP) between IP phone 54 at one end and IP phone 66 at the other end. IP phone accesses the Internet 60 through Internet Access Device (IAD) 56 and media gateway 58. IAD 56 may be any device used for accessing the Internet such as a modem, T1/T5 line, etc., as is known in the art. Gateway 58 is a gateway implementing ADPCM protocols with voice data samples packed into octets using little endian methods in the G.726-16, -24, -32, or 40 payload formats specified consistent with ITU X.420 recommendations.

On the other end of the network, IP phone 66 accesses the Internet 60 through Internet Access Device (IAD) 64 and media gateway 62. IAD 64 may be any device used for accessing the Internet such as a modem, T1/T5 line, etc., as is known in the art. Gateway 62 is a gateway implementing ADPCM protocols with voice data samples packed into octets using big endian methods for RTP payload formats in the ITU I.366.2 Annex E standards for ATM AAL2 transport.

In this section, we provide two example call flows using RTP package defined in [5] to achieve G.726 interoperability with an existing implementation which uses unknown G.726 payload format. The first one illustrates the case where the originating side is the intelligent gateway with the ability to determine the G.726 payload format and take corrective action, and the terminating side is legacy implementation. The second one is for the case when originating side is legacy gateway which is using unknown payload format for G726. The basic idea is to use the continuity test capability available in gateways that support the RTP package, and then intelligent gateways could decide if it needs to switch G726 payload format for call to succeed. Note that there is no need to indicate this capability or to define a new event to indicate the success. A dumb gateway that can not switch the payload format when the need arises or when continuity tests fails, is a hint for call agent to either drop the call or use some other encoding method. When the continuity test passes, the Call Agent proceeds with normal call flow procedure, and do not need to know the payload format details.

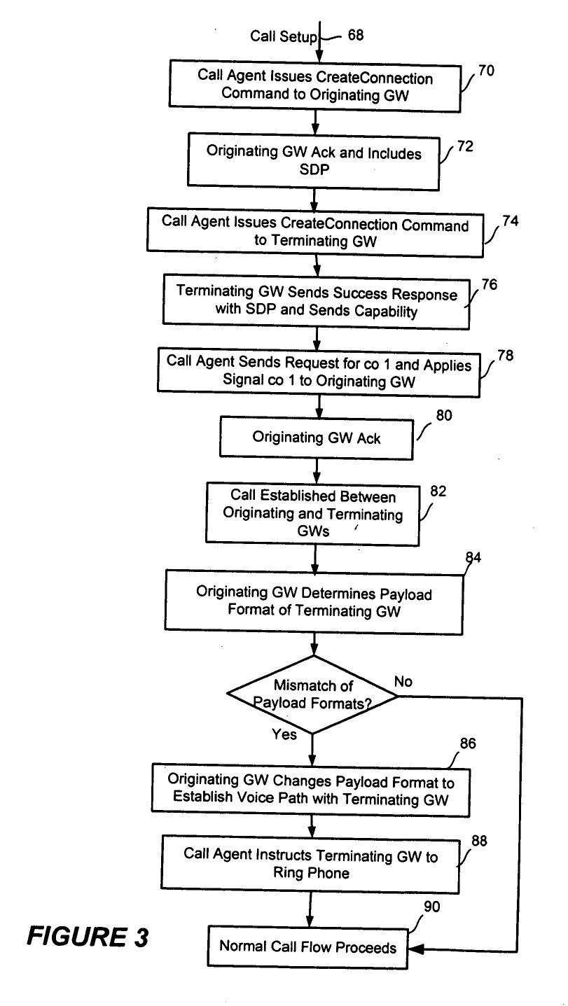

Referring to FIG. 3 a flowchart diagram demonstrates the preferred method for using signaling to determine ADPCM interoperability between intelligent originating gateway 58 and legacy terminating gateway 62. A Call Agent may reside in originating gateway 58 or a network device connected to gateway 58 on the originating end of a call. A call is setup 68 between originating intelligent gateway 58 and terminating legacy gateway 62. The call setup messages are as follows:

| # | GW-o | CA | GW-t |
|---|---|---|---|
| 1 | <− | CRCX (M:recvonly) | |
| 2 | 200 (sdp-o) | −> | |
| 3 | | CRCX (M:netwtest, S:, R:, sdp-o) | −> |
| 4 | | <− | 200 (sdp-t) |
| 5 | <− | MDCX (M:sendrecv, S:r/co1, | |
| | | R:r/co1, S:rt, sdp-t) | |
| 6 | 200 | −> | |
| 7 | NTFY (O:co1) | −> | |
| 8 | <− | 200 | |
| 9 | | MDCX (M:sendrecv, S:rg) | −> |
| 10 | | <− | 200 |
| 11 | | (Normal operations follow) | |

In the first step 70 the Call Agent in originating gateway 58 issues a CreateConnection command to terminating gateway 62 instructing it to use G726-32 media encoding upon receiving an off-hook notification using the following messages:

CRCX 100 aaln/1@gw-o.somewhere.net MGCP 1.0

C: 1

L: a:G726-32, p:20

M: recvonly

In the next step 72 the gateway acknowledges the command and includes SDP with following codec information:

200 100 OK

I:1

v=0

o=−25678 753849 IN IP4 10.0.34.121

s=−

c=IN IP4 10.0.34.121

t=0 0

m=audio 30000 RTP/AVP 96

a=rtpmap:96 G726-32/8000

The messaging continues in step 74 with the Call Agent issuing a CreateConnection command to the terminating gateway 64 instructing gateway 64 to use G726-32 media encoding (with an unknown payload format) and the connection mode is netwtest. The following messaging is used for the command:

CRCX 200 aaln/1@gw-t.somewhere.net MGCP 1.0

C: 2

L: a:G726-32, p:20

M: netwtest

v=0

o=−25678 753849 IN IP4 10.0.34.121

s=−

c=IN IP4 10.0.34.121

t=0 0

m=audio 30000 RTP/AVP 96

a=rtpmap:96 G726-32/8000

In the next step 76 the terminating gateway 62 sends back a success response to originating gateway 58 with its SDP which also includes capability information. The following messages are used to transmit the response:

200 200 OK

I:2

v=0

o=−25678 753849 IN IP4 10.10.10.1

s=−

c=IN IP4 10.10.10.1

t=0 0

m=audio 20000 RTP/AVP 2

In step 78 the Call Agent in turn transmits a ModifyConnection command to the originating gateway 58 and this time the command includes the request for event co1 and applies signal co1 (optionally duration can be specified) on the connection using the following messaging:

MDCX 101 aaln/1@gw-o.somewhere.net MGCP 1.0

C: 1

I: 1

M: sendrecv

X: a1

R: r/co1@1

S: rt, r/co1@1

v=0

o=−25678 753849 IN IP4 10.10.10.1

s=−

c=IN IP4 10.10.10.1

t=0 0

m=audio 20000 RTP/AVP 2

After receiving the command in step 78, the originating gateway 58 acknowledges the command 80. The acknowledgement is sent with the following message:

200 201 OK

At this point in the procedure, a call is established 82 is using G726-32 encoding where the terminating side is in loopback mode netwtest. Once a call is established 82, originating gateway 58 can employ any capable mechanism to verify the voice path or determine the payload format being used by terminating gateway 62. The Call Agent should allow sufficient time before giving up on event “co1” notification, and when none received, it can be assumed that the terminating gateway 62 has failed to verify the voice path in loopback mode, and can optionally specify timeout, and request events such as “oc/” (operation complete).

Thus, in step 84 originating gateway 58 determines the payload format in use by terminating gateway 62. Since originating gateway 58 is an intelligent gateway, after determining a mismatch with the format for the “dumb” legacy gateway 62, gateway 58 changes its own payload format 86 such that it is able to establish two way voice path with the terminating gateway 62 using encoding method G726-32. Originating gateway 58 then generates the notification for event co1 using the following messages:

NTFY 1001 aaln/1@gw-t.somewhere.net MGCP 1.0

O: r/co1@1

X: a1

The Call Agent acknowledges the Notify command using the message:

200 1001 OK

After acknowledgement of the Notify command, the Call Agent then instructs 88 terminating gateway 62 to ring the phone 66 and changes the connection mode to sendrecv. The following messages are used for step 88:

MDCX 201 aaln/1@gw-t.somewhere.net MGCP 1.0

C: 2

I: 2

M: sendrecv

R: rg

X: b2

The terminating gateway 62 acknowledges the commands sent in 88 by the Call Agent with the acknowledgement message:

200 201 OK

After the acknowledgement message is received by the Call Agent, the normal call flow can proceed 90. Terminating gateway 6 would eventually notify the call agent about an off-hook event, which will result in Call Agent stopping the ringback tone on the originating side. Once the ringback tone is stopped on the originating side, a two-way voice path is established between phone 54 and phone 66.

By employing the preferred embodiment in a communication network using ADPCM encoding for voice data signals, the possibility of call rejection or garbled speech will be eliminated and call completion rate would improve for encoding methods such as ITU G.726.

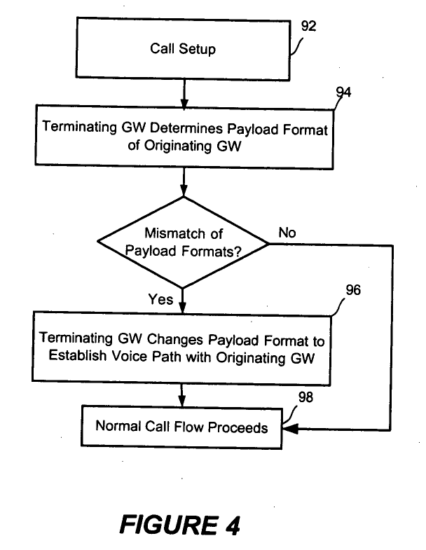

FIG. 4 illustrates a flowchart diagramming steps of an alternative embodiment for providing interoperability between two networks that use different bit packing formats for ADPCM-encoded voice data signals. Instead of providing payload format detection on the originating side, the alternative embodiment provides payload format detection support on the legacy, or “dumb,” leg of an IP call. In the alternative embodiment, the originating gateway 58 is assumed to be a legacy device that has an unknown payload format for encoding G.726 and cannot detect payload formats from other devices on the network nor change its own payload format. The terminating side 62 is the intelligent gateway that has the ability to detect G.726 format.

The call setup procedure 92 is enacted using the following messaging:

| # | GW-o | CA | GW-t |
|---|---|---|---|
| 1 | <− | CRCX (M:recvonly) | |
| 2 | 200 (sdp-o) | −> | |
| 3 | | CRCX(M:sendrecv, sdp-o) | −> |
| 4 | | <− | 200 (sdp-t) |
| 5 | <− | MDCX(M:netwtest, S:rt) | |
| 6 | | RQNT(R:r/co1, S:r/co1) | −> |
| 7 | | <− | 200 |
| 8 | | <− | NTFY (O:r/co1) |
| 9 | | 200 | −> |
| 9 | | RQNT(S:rg) | −> |
| 10 | | <− | 200 |
| 11 | | (Normal operations follow) | |

After call setup, the payload format for the currently transmitted voice data is determined 94 by the terminating gateway 62 and upon off-hook notification. If there is a mismatch between the payload format in the terminating gateway 62 and originating gateway 58, then terminating gateway 62 switches to a compatible payload format 96. The normal call flow follows 98 where the ringback tone on the originating side 58 is stopped and the connection put in sendrecv mode for a two way-voice call to be established between phones 54 and 66.

One skilled in the art will appreciate that the present invention can be practiced by other than the described embodiments, which are presented for purposes of illustration and not limitation, and the present invention is limited only by the claims that follow.

What is claimed:

1. A method to provide interoperability for ADPCM encoded voice data streams with incompatible payload formats, comprising:
transmitting, with a first media gateway, a first voice data signals encoded with ADPCM, wherein payloads of said voice data signals are formatted according to a first bit packing format;
transmitting, with a second media gateway, a second voice data signals that are formatted with an unknown bit packing format;
using a call agent to perform a continuity test on said second voice data signals from said second gateway; and
determining, with said continuity test, if said first bit packing format is compatible with said unknown bit packing format.

2. The method of claim 1, wherein said transmitting with a first gateway comprises transmitting with an intelligent gateway that has an ability to determine an ITU G.726 payload format of said second voice data signals and switch payload formats for said first voice data signals, and
said transmitting with a second media gateway comprises transmitting with a legacy gateway.

3. The method of claim 1, further comprising:
detecting a presence of garbled audio in said second voice data signals,
wherein said using comprises using a real time protocol of a media gateway control protocol to provide said call agent an ability to perform said detecting.

4. The method of claim 1, wherein said transmitting said first voice data signals comprises transmitting and receiving voice data signals according to an International Telecommunications Union (ITU) Recommendation G.726 format.

5. The method of claim 1, wherein said transmitted said first voice data signals comprises transmitting and receiving voice data payloads formatted according to one of a little endian and a big endian bit packing format, and
said determining comprises determining whether said second bit packing format is compatible with one of said little endian and said big endian bit packing format.

6. The method of claim 1, further comprising:
determining if a mismatch exists between said first bit packing format and said second bit packing format; and
if said mismatch exists, switching, in said first gateway, said first bit packing format to a compatible format to said second bit packing format.

7. The method of claim 1, further comprising:
determining if a mismatch exists between said first bit packing format and said second bit packing format; and
if said mismatch does not exist, said call agent proceeds to directs said first gateway to proceed with a call flow to connect said call between a first phone connected to said first gateway and a second phone connected to said second gateway.

8. A system to provide interoperability for ADPCM-encoded voice data streams with incompatible payload formats, comprising:
a first media gateway that transmits a first voice data signals encoded with ADPCM, wherein payloads of said voice data signals are formatted according to a first bit packing format;
a second media gateway that transmits a second voice data signals that are formatted with an unknown bit packing format; and
a processor, connected to said first gateway, that contains a call agent software module that performs a continuity test on said second voice data signals from said second gateway,
wherein said call agent determines if said first bit packing format is compatible with said unknown bit packing format using said continuity test.

9. The method of claim 8 wherein said first gateway comprises an ability to determine an ITU G.726 payload format of said second voice data signals and switch payload formats for said first voice data signals, and
said second media gateway is a legacy gateway.

10. The method of claim 9 wherein said software module uses a real time protocol of a media gateway control protocol to detect a presence of garbled audio in said second voice data signals.

11. The method of claim 8, wherein said first media gateway transmits said voice data signals according to an International Telecommunications Union (ITU) Recommendation G.726 format.

12. The method of claim 8, wherein said first gateway transmits said first voice data signals with voice data payloads formatted according to one of a little endian and a big endian bit packing format, and
said call agent determines whether said second bit packing format is compatible with one of said little endian and said big endian bit packing format.

13. The method of claim 8, wherein said call agent determines if a mismatch exists between said first bit packing format and said second bit packing format, and
if said mismatch exists, said first gateway switches said first bit packing format to a compatible format to said bit packing format.

14. The method of claim 8, wherein said call agent determines if a mismatch exists between said first bit packing format and said second bit packing format, and
if said mismatch does not exist, said call agent proceeds to direct said first gateway to proceed with a call flow to connect said call between a first phone connected to said first gateway and a second phone connected to said second gateway.
